(19) United States
(12) Patent Application Publication
(10) Pub. No.: US 2006/0122847 A1
(43) Pub. Date: Jun. 8, 2006

(54) Method for paying a user fee proposed by a service provider

(75) Inventors: Uwe Klatt, Oslo (NO); Manfred Lilge, Berlin (DE); Thomas Ryll, Wolfsburg (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/528,805

(22) PCT Filed: Sep. 24, 2003
(86) PCT No.: PCT/EP03/10639

§ 371 Date: Mar. 23, 2005

(30) Foreign Application Priority Data
Sep. 24, 2002 (DE) 102 44 463.3

(51) Int. Cl. G06Q 99/00; H04M 15/00; G07F 19/00

(52) U.S. Cl. 705/1; 705/34

(57) ABSTRACT

The invention relates to a method for paying a user fee proposed by a service provider by means of the terminal of a service user. The inventive method consists in calculating a payable amount with the aid of a billing device and in paying the payable amount by the bank account of the service user, thereby allowing said user to use a service. When requesting a service, the user can appoint the execution time for the service, the paying of the payable amount being carried out according to the execution time.

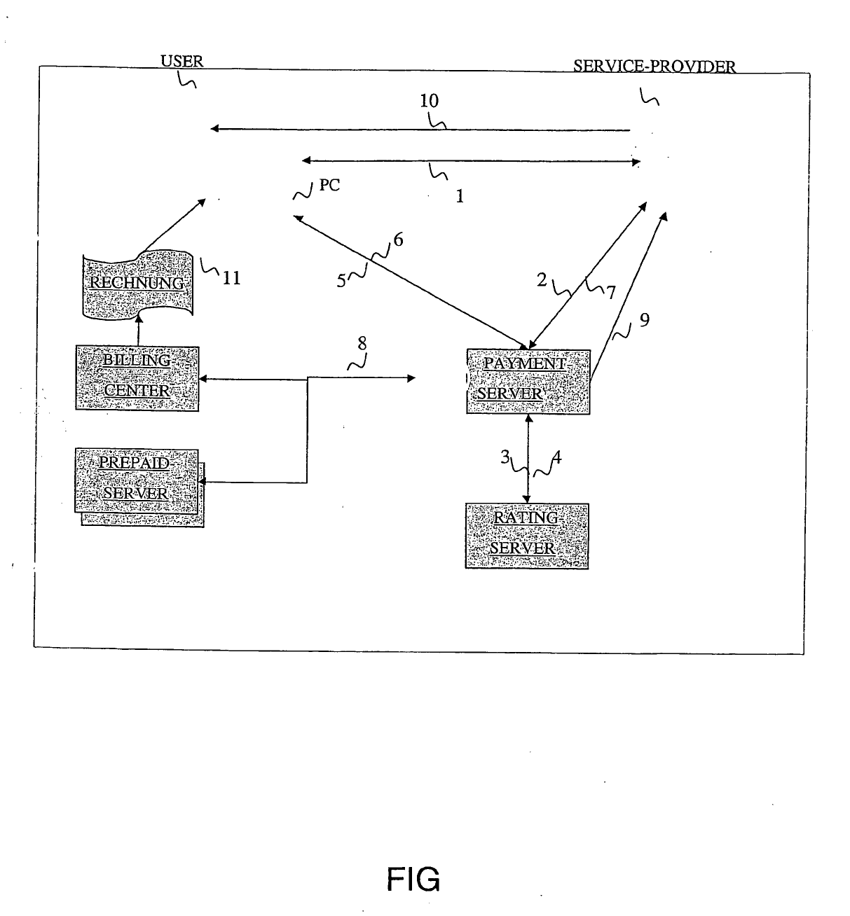

The invention relates to a method for paying a user fee proposed by a service provider in accordance with the preamble of Claim 1.

It is generally known that in communication networks fees for communication services are debited from credit accounts maintained in these communication networks (known as prepaid accounts). In such cases these credit accounts are assigned to one or more communication terminals (e.g. fixed network telephones, mobiles, PDAs (Personal Digital Assistants), notebooks, computers) registered in the communication network. Some of these credit accounts are also assigned to subscribers, for example a number of members of a family who use one terminal. Such a communication terminal may continue to establish and execute communication connections for as long as the credit account assigned to it remains in credit. If the credit for paying the fee is used up, no more communication connections can be established or existing communication connections are interrupted.

Furthermore there are methods known whereby the credit account is maintained in the communication network in which the communication connections are also established and thereby the services are provided. The operator of this type of communication network has access to the credit accounts maintained in his communication network and can accordingly deduct credit amounts from the credit account for the services provided in the communication network.

In modern communication networks mechanisms are now known by which even service providers who are independent of the communication network can provide services for the terminals connected to the communication network; The communication network is in such cases “opened up” as it were to the independent providers. Independent service providers here should be taken to mean those providers who are not the operator of the communication network.

These types of mechanism are known under the name of OSA (Open Service Architecture) or Parlay. Such independent service providers are also referred to as “Third Party Service Providers”.

For example, in so-called electronic commerce (e-commerce) there is the need to execute payment transactions using communication networks. Such payment transactions can arise when goods or services subject to a fee are provided over the communication networks for example (e.g. supply of information, data or goods). The Internet or telecommunication networks (mobile radio network, fixed-line networks) are typically used as these types of communication networks. To pay for the goods or services methods are for example needed for cashless payment using a mobile terminal (e.g. a mobile phone, a laptop, Personal Digital Assistant PDA or palmtop) and/or an Internet terminal (e.g. Internet computer). The disadvantage of these e-/m-commerce systems is that at the time that services are requested by a user the account must have sufficient credit to cover the fee. The underlying object of the invention is to specify a method for paying a user fee proposed by a service provider which guarantees increased flexibility in the handling of billing.

This object is achieved, using as its starting point the method for paying a user fee proposed by a service provider in accord of the preamble of Claim 1, by the characterizing features of said claim.

With the method in accordance with the invention for paying a user fee proposed by a service provider by a user's terminal, in which, for the use of a service by a fee is determined by a billing device and the deduction of the fee from a service user's credit account is initiated, a time for the execution of the service can be defined at the time that the service is requested, with the point at which the fee is deducted being dependent on the execution time.

The method in accordance with the invention gives greater flexibility for execution of payment transactions within the framework of the usage of services. One of the ways in which this flexibility is expressed is that the service user can exert influence on the point at which the fee is deducted and/or level of the fee by explicitly selecting the execution time, and another is that he generally has the freedom to have services executed at a point other than the point at which they were requested.

In a possible further development a level of fee arising at the point of execution is determined at the time of the request and, after the execution time is determined, the deduction of the fee is initiated at the time of the request. This method of operation is especially advantageous if the price for providing the service diverges over time, so that although the service user's account is debited at the time of the request, he can still reduce the costs arising by skillful selection of the execution time. This is helpful for example if the credit account does not cover the costs for using the service at the time of the request.

Alternatively, after the execution time is defined, the deduction of the fee is initiated at the point of execution. The advantage of this is that if the service user has insufficient credit at the time of the request for example, despite the funds being unavailable to cover it, the service can still be requested, since the amount is not deducted until later and the service user is given the opportunity to stock up the account with credit accordingly by the execution time. This variant thus allows the service user an increased level of control over his fees, even if the prices for the service do not diverge over time, or allows the service to be used despite there being insufficient credit in the account to cover it at the time of the request.

If the price of a service diverges as a function of the time at which it is executed, optimum flexibility in timing and costs is obtained if a level of the fee arising at the point of service execution is also determined at the time of request. This means that both the credit can be preserved at the time of the request and a reduction in the costs arising can be achieved.

Preferably, at the time of the request, before the execution time is determined by the terminal, at least a first service request message is sent to the billing device, with the service request message, in addition to parameters identifying the service, also containing its execution time, so the determination of the level of fees can be initiated by the billing device on the basis of the execution time and/or the parameters, with the level of fees determined subsequently being transmitted to the terminal and displayed to the service user together with a request to enter a confirmation, so that, on confirmation on the part of the service user the execution time is determined and this is transmitted to the billing device and the billing device, at the point at which the service is executed, then attempts to deduct the fee from the service user's credit, with, if the attempt is successful, the provision of the service by the service provider being released by the billing device, by the transfer of a corresponding message to the service provider for example. This further development guarantees a simple-to-implement execution sequence, with the execution of transactions related to the payment of fees by the billing device having the advantage that the method in accordance with the invention can essentially be employed in existing e-/m-commerce (payment) systems without any great modification, since in such systems in general billing for services by a billing device is implemented as a standardized interface, for example an interface in accordance with “PayCircle” or the “Open Service Access (OSA)” standard.

Advantageously in this case the execution time can be rejected by entering an alternative execution time and/or entering the alternative execution time, with steps a) to c) repeated with the alternative execution time. A negotiation of the desired time is implemented with this methodology.

Preferably the amount of the fee is determined in this case by a device for determining billing, taking into account at least one tariff model, after initiation on the part of the billing device by the transfer of a suitable message, with at least the parameters of the desired service as well as execution time. It is advantageous for determination of payment amounts by a billing device for existing payment rating facilities, for example the “Least Cost Routing” system, to be able to be included to support the inventive method. On the one hand this reduces the effort involved in implementation since it involves accessing existing systems which essentially only have to be slightly adapted and on the other hand redundancy in the provision of functions is avoided or available resources are used more effectively. In addition existing billing devices can essentially be used, which enhances the advantages already mentioned.

If at least one tariff table is administered by the payment rating device to take account of the tariff model, the tariff rating can be simply implemented by using a table. In addition administration ensures that current tariff models are always available.

Further advantages and details of the invention are explained with reference to the single FIGURE. The drawing shows

FIGURE a schematic diagram of the execution sequence according to an exemplary embodiment of the method in accordance with the invention.

The FIGURE shows the execution sequence of the method in accordance with the invention using an application scenario as an exemplary embodiment. This scenario assumes that a service user USER possesses a multimedia-enabled terminal PC, for example a Personal Computer, as well as having a credit account available on a PREPAID SERVER.

As an alternative to or supplementary to the exemplary embodiment, the service user can also have a BILLING CENTER system which implements billing at the end of a billing cycle by producing a bill—i.e. by sending a bill BILLING, so that the actual payment occurs after the service i.e. “post-paid”.

The inventive method is employed in accordance with the scenario when the USER wishes to make use of a service provided by a SERVICE PROVIDER, in this example a video stream that can be played back on his terminal.

To do this the USER, in a first step S1, establishes a connection via his terminal PC to the SERVICE PROVIDER, with the term SERVICE PROVIDER being used below as a simple way of referring to any arrangement which implements the service. Using the connection, which is generally bidirectional as a result of the exchange of data in both directions, the USER requests the SERVICE PROVIDER to transmit this video stream to him, with the execution time being at night, i.e. not at the time that the request is made.

As part of this request, the data identifying the service, for example the video title, and the resulting parameters, for example the duration of the video stream, are transmitted to the SERVICE PROVIDER.

Using this data and also the execution time, the SERVICE PROVIDER, in a second step S2, initiates a payment transaction, which, as is normal in e-/m-commerce systems, is to be executed by a standardized interface for payment handling (payment interface or payment server) PAYMENT SERVER.

Since at this point the data still does not contain any price indication, an inquiry to determine the payment is initiated in a third step S3 by the PAYMENT SERVER. To this end, in accordance with the exemplary embodiment, a separate RATING SERVER. is provided in which the current tariff model of the SERVICE PROVIDER is stored, in the form of a table for example. At the request of the PAYMENT SERVER the price is determined on the basis of the data associated with the service request as well as customer-specific data such as any usage discount arising or a loyalty bonus, in which case, in accordance with the scenario of the exemplary embodiment, the SERVICE PROVIDER offers the download of video streams at a more favorable rate at night so that a correspondingly more favorable fee is determined by the RATING SERVER.

The level of the fee determined is subsequently transmitted in a fourth step S4 to the PAYMENT SERVER and transmitted from this server in a fifth step S5 directly to the terminal PC of the USER and displayed to the USER there.

If the USER agrees with the amount billed he authorizes the transaction. I.e. he conforms his service request made in the first step S1, so that in a sixth step S6, the data associated with the transaction is stored in a database of the PAYMENT SERVER and also in a seventh step S7 a confirmation is transmitted by the PAYMENT SERVER to the SERVICE PROVIDER indicating to the SERVICE PROVIDER that the payment transaction that it has initiated has been authorized by the USER and the data has been stored in the PAYMENT SERVER, so that the SERVICE PROVIDER for its part can make arrangements for the service to be provided at the desired point in time.

When the execution time is reached, in an eighth step S8, the PAYMENT SERVER attempts to deduct the fee previously determined. This can be done by debiting the PREPAID SERVER credit account or alternatively or additionally by billing (post-paid) via a BILLING CENTER.

If the deduction process is successful, in a ninth step S9 the SERVICE PROVIDER receives a message, with which the release of the provision of the service is indicated, so that in a tenth step S10 the video download can be undertaken by the terminal PC of the USER.

If the deduction process in the eighth step S8 via the billing system is completed, the billing process is completed in an eleventh step S11 by sending BILLING at the end of the billing cycle, for example at the end of the month.

As an alternative to the process described it is also conceivable that the USER does not agree to the fee proposed.

In this case the USER could specify another execution time. It is also conceivable for the USER, in the first step S1 when requesting the service, to have a number of alternative times with the corresponding fees or the tariff model of the SERVICE-PROVIDER displayed on his terminal.

The invention is not to be restricted solely to the example shown but is to include variations, for example in the sequence of the procedural steps discussed. Variations of the arrangement scenario should also be included. Thus it is conceivable for example for the PAYMENT SERVER to include the RATING SERVER, i.e. for the PAYMENT SERVER to implement the functionality of the steps of the RATING SERVER. It is also conceivable for the PAYMENT SERVER and/or the RATING SERVER to be part of the SERVICE PROVIDER.

An infrastructure necessary for the units to communicate is typically provided, as is usual with e-/m-commerce systems, by a mobile radio network or other communication networks, with at least part of the arrangement described, for example the BILLING CENTER or the PREPAID SERVER maintaining the credit accounts, being assigned to the network provider.

1. Method for paying a user fee proposed by a SERVICE PROVIDER via a terminal (PC) of a USER, in which, for the use of a service, a fee is determined by a PAYMENT SERVER and the deduction of the payment from a credit account (PREPAID SERVER, BILLING CENTER) of the USER is initiated, characterized in that,
a) at the time at which the service is requested a time for execution of the service (S1) can be defined by the service user,
b) the fee is deducted depending on the execution time (S2 . . . S11).

2. Method in accordance with claim 1, characterized in that, at the time of the request, a fee amount arising at the time of execution is determined (S2 . . . S4) and after determination of the execution time (S1) the deduction of the fee is initiated at the request time.

3. Method in accordance with claim 1, characterized in that, after the execution time is determined (S1, S6, S7) the deduction of the fee at the execution time (S8, S9) is initiated.

4. Method in accordance with claim 3, characterized in that, at the time of the request, the level of fee arising at the execution time is determined (S2 . . . S4).

5. Method in accordance with claim 3, characterized in that
a) at the time of the request, before the execution time is determined, at least a first data request is sent from the terminal (PC) to the PAYMENT SERVER (S2), with the service request message containing the execution time as well as parameters identifying the service,
b) the PAYMENT SERVER initiates a rating of the level of fee based on the execution time and/or the parameters (S3, S4),
c) the level of fee determined is transmitted to the terminal transmitting and displayed to the service user with a request to enter a confirmation (S5),
d) with a confirmation on the part of the user of the execution time is defined (S6) and this is transmitted to the payment server (S7),
e) the PAYMENT SERVER attempts at the execution time to deduct the fee from the user's credit (S8),
f) if the attempt is successful the provision of the service is released by the service provider (S9).

6. Method in accordance with claim 5, characterized in that
d2) the execution time is rejected by an entry of an alternative execution time and/or entry of the alternative execution time,
e2) steps a) to c) are repeated with the alternative execution time.

7. Method according to claim 5, characterized in that the PAYMENT SERVER rates the level of the fee by using a RATING SERVER taking into account at least one tariff model (S3, S4).

8. Method in accordance with claim 7, characterized in that, to enable account to be taken of the tariff model, at least one tariff table is administered by the RATING SERVER.
